(19) United States
(12) Patent Application Publication
(10) Pub. No.: US 2007/0248710 A1
(43) Pub. Date: Oct. 25, 2007

(54) SYSTEM AND METHOD FOR MAKING A COMPRESSED EARTH BLOCK

(75) Inventor: Jim Jennings, California, MD (US)

Correspondence Address: NOVAK DRUCE + QUIGG LLP, 10415 SOUTHERN MARYLAND BLVD., DUNKIRK, MD, 20754, US

(73) Assignee: Thomas M. Isaacson, Huntingtown, MD (US)

(21) Appl. No.: 11/694,566

(22) Filed: Mar. 30, 2007

Related U.S. Application Data
(60) Provisional application No. 60/744,072, filed on Mar. 31, 2006.
(60) Provisional application No. 60/744,073, filed on Mar. 31, 2006.

(51) Int. Cl. B28B 17/00

(52) U.S. Cl. 425/219

(57) ABSTRACT

The system and method are disclosed for compressing brick. The system comprises of the top compression plate, a lower compression plate having a tongue on its top surface, a deck having a tongue that when a lower plate is in an up position integrates with the deck and tongue and a tray having a first wall with a groove that integrates with the tongues of lower plate and the deck.

### PRIORITY CLAIM

The present application claims priority to U.S. provisional Application Nos. 60/744,072, filed Mar. 31, 2006 and 60/744,073, filed Mar. 31, 2006, the contents of each application is incorporated herein by reference.

### BACKGROUND OF THE INVENTION

1. Field of the Invention

The present invention relates to making bricks or blocks and more specifically to a system, operating system, method for making compressed earth blocks as well blocks made by the method.

2. Introduction

There are several patents that relate to compressed earth block machines. These are U.S. Pat. Nos. 6,302,675, 6,555,040, 5,629,033, and 6,736,626. Each of these is incorporated herein by reference as background material. There are several deficiencies in the design of these compressed earth machines that are addressed by the invention disclosed herein.

The '675 patent shows, in FIG. 12, a hinge plate 21 that is connected by a hinge 32 to a baffle 43 extending across the top forward portion of the feed drawer. This hinged arrangement can cause problems. If the press foot is raised to high when the feed drawer moves from left to right for screeding across the press foot, then the hinge plate can be damaged. This is a problem experienced by the present inventor in operating the compressed brick machine.

Further, these patents disclose a process related to how the bricks are compressed. They show that a bucking foot 50 is lowered to define a chamber for compression and the compression process occurs by having the operator push a lever which causes a press foot 20 to be raised to a third level 25 in the breech. This process of using the lower press foot 20 and raising it into a second position and then utilizing a third position for compressing the brick causes problems wherein the brick or a press foot 20 can get stuck in a higher position thus causing the problem with screeding discussed above. In the prior art, a valve associated with the bottom plate also can stick. When this occurs, the bottom plate won't go down, but the tray will still be pulled back. When that happens, the wall plate in the tray of the prior art can break off on the elevated lower plate. For example, the hinged wall 41 or other wall of the tray can break off which can both be dangerous and cause a costly delay in productivity.

Furthermore, prior art systems require the level of the compression chamber to be too high where if soil is manually being fed into the hopper it requires laborers to lift the soil to a higher level. Furthermore, there are more mechanisms and controls needed to raise the press foot to varying levels.

Accordingly, what is needed in the art is an improvement in design that does not damage components associated with the feed drawer when in operation, lowers the level of the hopper and that is more simple and efficient.

### SUMMARY OF THE INVENTION

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

The invention provides for a system, method blocks, and operating system for operating a compressed brick machine. The method embodiment comprises receiving soil or an appropriate mixture as is known in the art for compressing blocks, into a tray having a first wall with a notch, the tray being at a first position, moving the tray into a second position wherein moving the tray causes a first compressed brick to be pushed onto a deck having a tongue that integrates with a groove in the brick and with the notch in the first wall of the tray, lowering a lower plate to create a portion of a compression chamber that receives the soil, lowering a compression plate in a vertical position over the lower plate to create a compression chamber, compressing the soil in the compression chamber by lowering the compression plate to create a second compression brick, raising the compression plate and raising the lower plate to lift the second compressed brick into a level position with the deck.

The system includes a top compression plate, a lower compression plate having a tongue on its top surface, a deck having a tongue that when the lower plate is in an up position matches the deck and tongue, and a tray having a first wall with a groove that integrates with the tongues of the lower plate and the deck. The top compression plate also has a groove that is compressed into the compressed brick as a tongue. The tongue is preferably rectangular but may be any shape. For example, the tongue may be different shapes such as curved or jagged, or so forth. Preferably, the tongue 402 on the deck, lower press plate tongue 604A and the notch in the tray 502 showed to be mirror images or be able to integrate with each other. The tray matches the tongue so that when the soil comes out, it only comes out to a certain point, the slide tray comes out to that point and on the next cycle, the lower plate shifts down and the soil tray would track and it doesn't leave any debris, so the preferred embodiment does not need to sweep because the bottom plate has been lowered so there is no reason to screed across the plate. The lower plate is then lowered and ready to fill up again with the soil mixture.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIGS. 1-3 illustrate various views of a compressed block machine;

FIG. 4A illustrates a machine according to an embodiment of the invention;

FIG. 4B illustrates another view of a machine according to the invention;

FIG. 4C illustrates an aspect of the invention;

FIG. 5 illustrates a feeder tray;

FIGS. 6A-6E illustrate a cycle for creating a compressed brick; and

FIG. 7 illustrates a method embodiment of the invention.

### DETAILED DESCRIPTION OF THE INVENTION

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

The present invention comprises several embodiments including, but not limited to, a compressed brick, a system for generating a compressed brick, an operating system for controlling a machine to compress brick, and a method of generating a compressed brick.

The '675 patent incorporated above discloses and claims an orthogonal breech, a press foot, a feed drawer, and a bucking foot and a surface coplanar with the feed drawer open lower end. The feed drawers as shown in FIG. 12 each require a hinged wall 41 following the fixed wall with a lower edge for screeding along the breech open upper end during the rearward motion of the feed drawer and for clearing above the three dimensional surface of the press foot during forward motion of the feed drawer. FIG. 12 of the '675 patent shows the hinge 42 and the hinged wall 41. They also include a roller 47 which enables the hinged wall 41 to pivot towards the inner part of the feed drawer when the feed drawer is moved into registration with the breech.

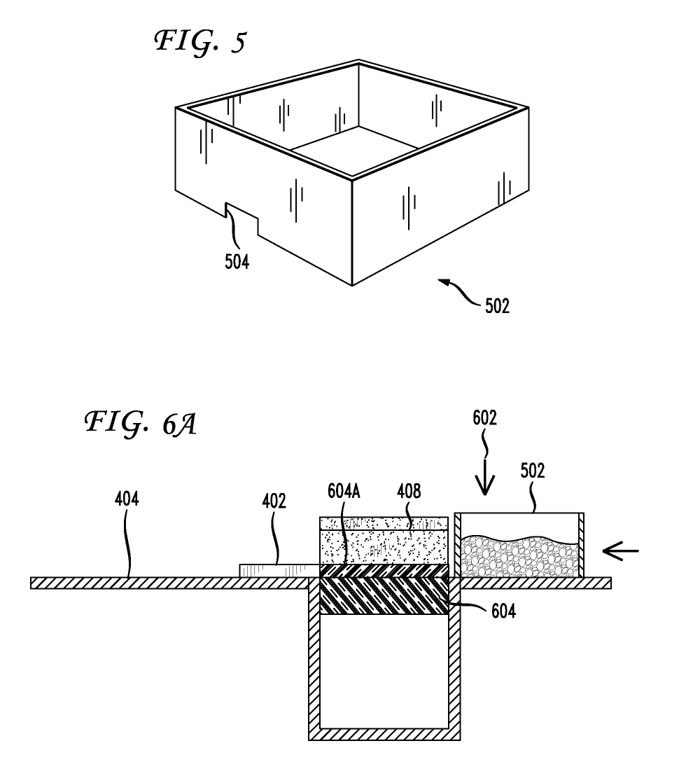

The present inventor has improved upon the prior art by removing the hinged wall and replace it with a flexible wall such as a nylon wall, rubber wall, a wall having bristles like a broom, or any other kind of flexible material. It is preferably that the new wall be attached to the fixed wall 39 (see FIGS. 12 and 13 of the '675 patent). This may be done via any structure such as screws, glue, spot welding, or any other known method of fixing the new wall to wall 39. In another preferred embodiment, the wall is fixed and has a notch at the bottom. This configuration is shown in FIG. 5 of the '675 patent.

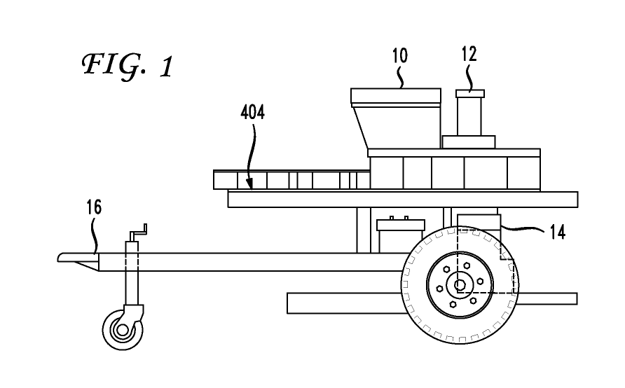

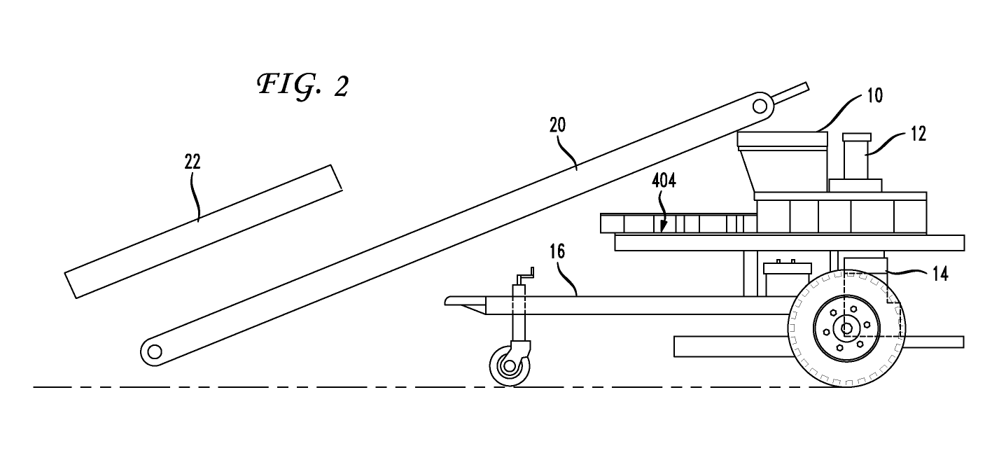

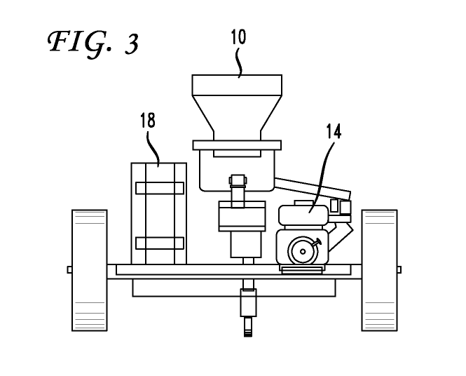

Generally, the figures referenced next will be those in the present application. FIG. 1-3 provide some details regarding the overall structure of compressed brick machines according to the invention. Further details will be described in the following information. For example, the tongue may be different shapes such as curved or jagged, or so forth. Preferably, the tongue 402 on the deck, lower press plate tongue 604A and the notch in the tray 502 showed to be mirror images or be able to integrate with each other. The tray matches the tongue so that when the soil comes out, it only comes out to a certain point, the slide tray comes out to that point and on the next cycle, the lower plate shifts down and the soil tray would track and it doesn't leave any debris, so the preferred embodiment does not need to sweep because the bottom plate has been lowered so there is no reason to screed across the plate. The lower plate is then lowered and ready to fill up again with the soil mixture.

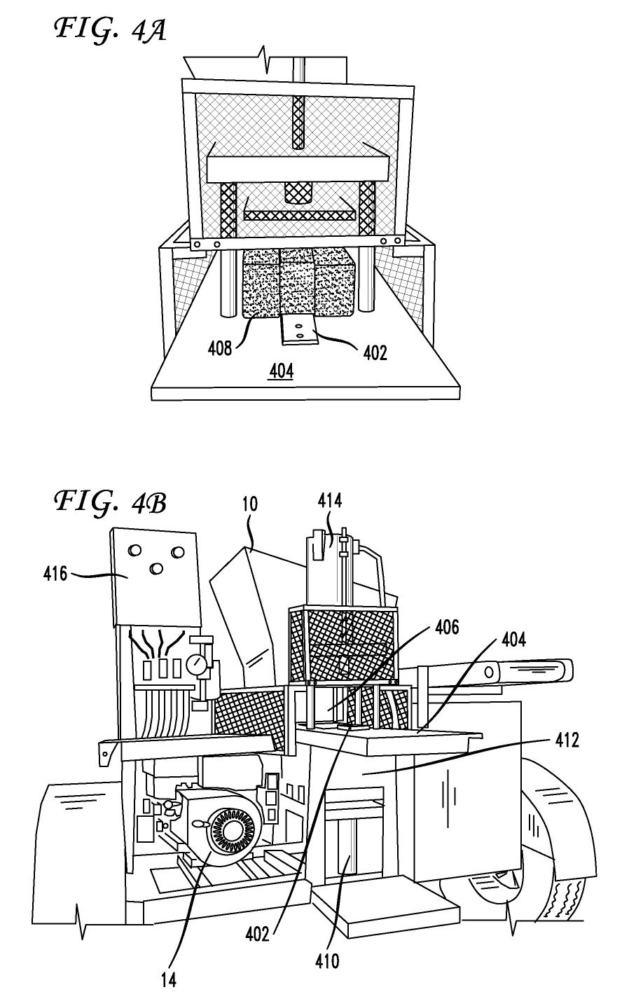

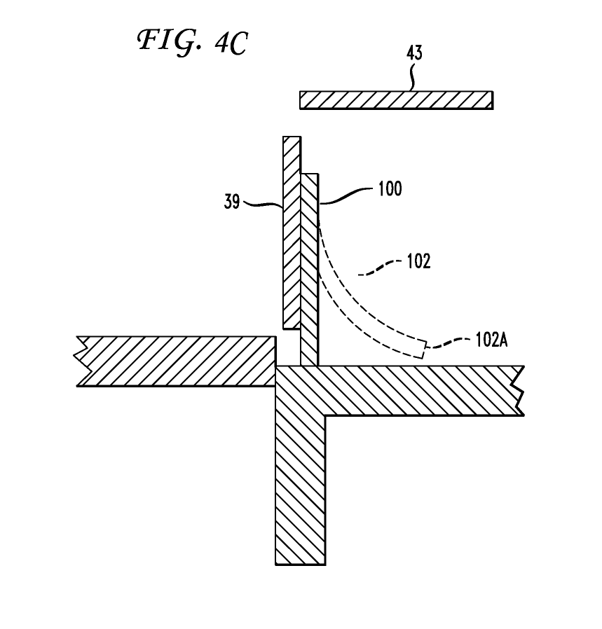

FIG. 4C illustrates the wall 39 with a flexible wall 100 also shown in a flexed position 102. In this configuration, as the feed drawer (not shown) is moved into position over the breech, the lower edge 102A of the flexible wall 100 strikes the three dimensional portions of the upper face of the press foot 20. The wall 102 flexes rearwardly so that the lower edge of the wall 102 rides on the uppermost portion of the press foot. When the feed drawer 30 is withdrawn to registration with the hopper 60, the rearward motion of the feed drawer 30 together with the excess material in the feed drawer 30 causes the flexible wall 100 to return to its normal vertical position to screed along the planar surface during withdrawal. Because the wall 100 is flexible, as it returns back over the press foot, if the press foot is a little high, the wall will flex rather than break as it engages with the press foot. The flexible wall provides an aspect of the present invention.

Another embodiment of the invention does not need to use the flexible wall. A preferred embodiment of the invention is shown in FIGS. 4A and 4B. These figures show a compressed brick machine having a deck 404, a tongue 402 and a completed compressed brick 408. The compression chamber where the compression of soils occurs to make the brick is shown as chamber 412. Hydraulics 414, 410 or some other type of mechanism may be used to raise and lower plates for compression. A control system 416 is manipulated by an operator.

The preferred embodiment of the invention simplifies the feeder tray such that it does not need a hinged plate. An example feeder tray 502 is shown in FIG. 5 having a groove 504 that mirrors the shape of the tongue 402. The tray 502 preferably does not have a bottom surface such that as it moves over a compression chamber when a lower plate is down, the soil will drop down into the chamber, as will be shown below.

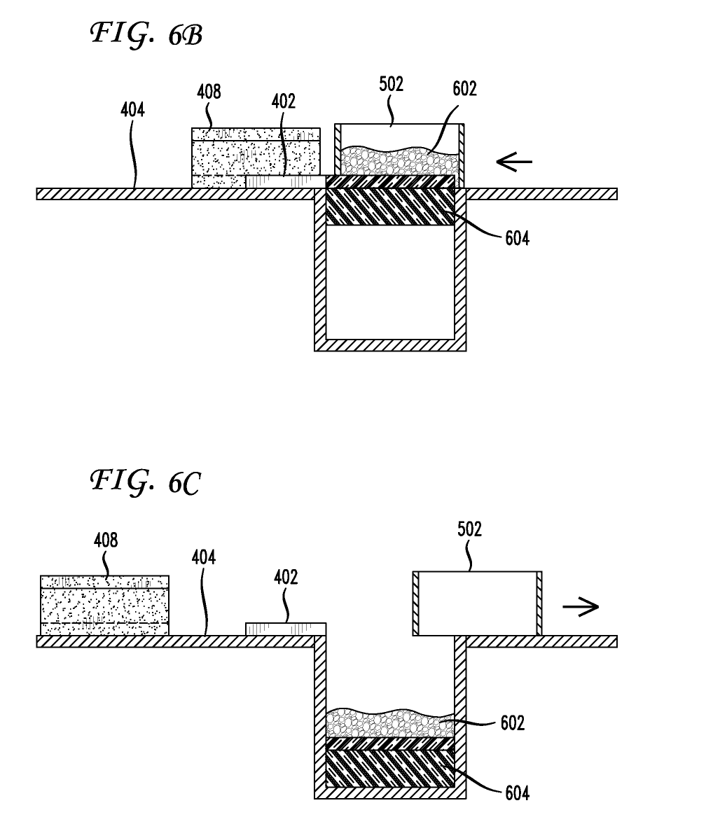

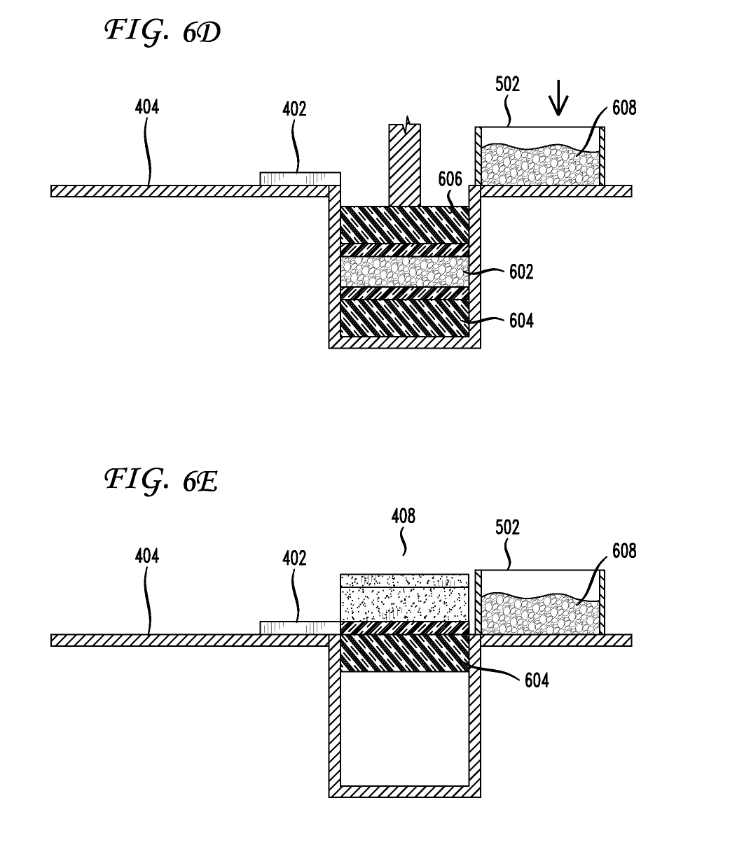

FIGS. 6A-6E show the cycle. In FIG. 6A, the feeder tray 502 is positioned over a hopper (not shown) such that new soil 602 can be introduced into the tray 502. A compressed block from a previous cycle is shown 408. A lower plate 604 includes a tongue 604A that matches tongue 402 such that when it is elevated, the deck 404 and tongue 402 continue with the same surface arrangement as corresponding surfaces in the lower plate 604 and tongue 604A. FIG. 6B shows the tray 502 pushing to the left and forcing block 408 to the left and onto the deck 404. Because the wall and notch 504 of the tray 502 match the deck 404 and tongue 402 surfaces as well as the lower plate 604 and tongue 604A, and because the compressed brick also has a groove along its lower surface that is shown in FIG. 4A, as the tray 502 pushes the block to the left, tongue 402 prevents soil 602 from being pushed out onto the deck 404. In this regard, there is no need for the hinged wall of the prior art, thus simplifying the design and down-time of the machine.

FIG. 6C shows the lower plate 604 dropping into a lower position with the soil 602 dropping as well. This moves the soil into a compression chamber position. See FIG. 4B 412. The tray 502 then retreats back to the right. FIG. 6D shows the top compression plate 606 coming down to complete the compression chamber and to compress the soil 602 into a brick 408. FIG. 6E shows the lower plate 604 raising to position the compressed brick 408 into a position where the tray 502 having a new supply of soil 608 can push the compressed brick 408 out onto the deck 404 while simultaneously providing new soil for the next block.

The feeder tray 502 is a simple tray—there is no need for a baffle on top of the feeder tray as is in the prior art patents for attaching a hinge. In the prior art, there is no tongue on the deck, so when the bottom plate is up and the block is being pushed out, the tongue on the lower plate is above the flat, planar deck. Thus the prior art needed the sweep to bring the soil back off the deck. With the preferred embodiment, without the tongue on the deck, a trail of soil would be left and need to be brought back. With the modification disclosed herein, the soil 602 does not escape onto the deck 404 as a block 408 is pushed from the chamber.

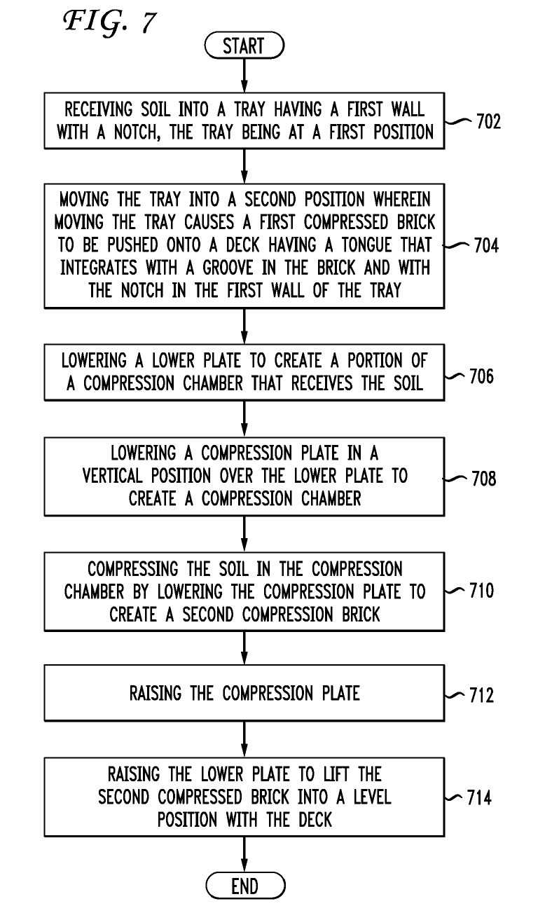

The method aspect of the invention is shown in FIG. 7 which shows comprises receiving soil into a tray having a first wall with a notch (702), the tray being at a first position, moving the tray into a second position wherein moving the tray causes a first compressed brick to be pushed onto a deck having a tongue that integrates with a groove in the brick (704), lowering a lower plate to create a portion of a compression chamber that receives the soil (706), lowering a compression plate in a vertical position over the lower plate to create a compression chamber (708), compressing the soil in the compression chamber to create a second compression brick (710), raising the compression plate (712), and raising the lower plate to lift the second compressed brick into a level position with the deck (714).

There are advantages to this approach. As has been discussed, the design of the compressed block system requires a person to shovel the sand and cement mixture into a feeder bucket that delivers the mixture to the feed drawer. That feeder bucket is elevated in the air. By lowering the compression plate, there will not be as much movement in the pressing foot or lower plate since it is no longer raised to a third level for compression, the X-axis movement of the feed drawer may be lowered and thus the feeder bucket into which the mixture is shoveled may be lowered. Therefore, there are several advantages to lowering the bucking foot into the compression chamber to compress the soil mixture.

The system operating according to the principles of the invention will have a known engine, controls and hydraulic system to complete the steps and structure described herein. Examples of such features are shown in FIGS. 4A and 4B.

The system preferably uses proximity switches, and it can be called a bucking cylinder. The height of the compressed brick is adjustable if one wants to make brick or pavers by changing how much compression is done. Preferably, the bricks are 4 inches tall by 8 inches wide by 12 inches deep. Those of skill in the art will understand the basic control mechanisms for the moderation and for compression. A control system 416 utilizes known as basic features to control a hydraulic or other network to move the various components such as the compression plate, lower plate, the tray and so forth. Furthermore, typically the control system will receive input from a human operator to either initialize the movement of various plates and tray according the steps set forth herein or in a manual fashion according to the capabilities and programming of the control system. The control system 316 includes various modules programmed according to principles known to those of skill in the art. The various modules will manage both the interaction of an operator with the system such as to receive input from the user as well as to control the hydraulics or the other types of systems within a compressed brick system to manage and control the various functions in order to compress brick according to the principles in the invention. For example, various modules will be programmed to control the movement of tray 502 in a preferable horizontal left and right movement into a first position and a second position. A module will be configured to manage the up and down movement of a top compression plate into its appropriate positions. Further a module will be configured to control the movement of the lower plate into its various positions so that it can receive soil and with the top compression plate create a compression chamber for compressing the brick and in connection with the horizontal movement of the tray 502 being able to raise the compressed brick into the appropriate position to be pushed out onto the deck 404.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

Although the above description may contain specific details, they should not be construed as limiting the claims in any way. Other configurations of the described embodiments of the invention are part of the scope of this invention. For example, the control system of the machine may be operated manually or automatically via computer controls. A computer may be programmed with sensors to handle the operation and function of the machine as set forth above, wherein a user may only have to monitor the machine as it cycles through to create compressed bricks. Accordingly, the appended claims and their legal equivalents should only define the invention, rather than any specific examples given.

I claim: System:

1. A system for compressing brick, comprising:
a top compression plate;
a lower plate having a tongue on its top surface;
a deck having a tongue that when the lower plate is in an up position the deck tongue integrates with the lower plate tongue; and
a tray having a first wall with a groove that integrates with the deck tongue and lower plate tongue as the tray moves in a horizontal direction.

2. The system of claim 1, wherein the deck having the tongue receives a compressed brick as it is pushed away by the tray.

3. The system of claim 1, wherein the deck tongue is integral with a groove in the compressed brick such that as the tray pushes the compressed brick onto the deck, there is no need to screed across the lower plate.

4. The system of claim 1, wherein the top compression plate has a groove on its lower surface.

5. The system of claim 1, further comprising of the control system that control a hydraulic network to move the top compression plate, the lower plate and the tray.

6. A method of operating a compressed brick machine, the method comprising:
receiving soil into a tray having a first wall with a notch, the tray being at a first position;
moving the tray into a second position wherein moving the tray causes a first compressed brick to be pushed onto a deck having a tongue that integrates with a groove in the brick and with the notch in the first wall of the tray;
lowering a lower plate to create at least a portion of a compression chamber that receives the soil;
compressing the soil in the compression chamber by lowering a compression plate to create a second compression brick;
raising the compression plate; and
raising the lower plate to lift the second compressed brick into a level position with the deck.

7. The method of claim 6, further comprising:
receiving more soil into the tray in the first position; and
moving the tray into the second position to push the second compressed brick onto the deck having the tongue.

8. The method of claim 6, wherein the lower plate has a tongue that integrates with the tongue on the deck.

9. The method of claim 6, further comprising receiving input from an operator to move the compression plate, the lower plate and tray via a control system.

10. A compressed brick generated by a process comprising:
receiving soil into a tray having a first wall with a notch, the tray being at a first position;
moving the tray into a second position wherein moving the tray causes a first compressed brick to be pushed onto a deck having a tongue that integrates with a groove in the brick and with the notch in the first wall of the tray;
lowering a lower plate to create at least a portion of a compression chamber that receives the soil;
compressing the soil in the compression chamber by lowering a compression plate to create a second compression brick;
raising the compression plate; and
raising the lower plate to lift the second compressed brick into a level position with the deck.

11. The compressed brick generated by the process of claim 10, wherein the method further comprises:
receiving more soil into the tray and the first position; and
moving the tray into the second position to push the second compressed brick onto the deck having the tongue.

12. The compressed brick of claim 10 wherein the lower the tongue that matches the tongue on the deck.

13. A control system integrated with a system for compressing bricks, the control system comprising a module configured to receive user input;
upon receiving user input, a module configured to a tray from a first position for receiving soil into a second position wherein moving a tray cause the first compressed brick to be pushed onto a deck having a tongue that integrates with the groove in a brick and with a notch in a first wall of the tray;
a module configured to lower a lower plate to create at least a portion of a compression chamber that receives the soil when the tray is moved into the second position;
a module configured to compress the soil in the compression chamber by lowering a compression plate to create a second compression brick;
a module configured to raise the compression plate; and
a module configured to raise the lower plate to lift the second compressed brick into the level position with the deck.

14. The control system of claim 13, further comprising:
a module configured to move the tray into the first position wherein additional soil is received into the tray; and
a module configured to move the tray again into the second position while pushing the compressed brick onto the deck having a tongue.
